(19) United States
(12) Patent Application Publication
(10) Pub. No.: US 2015/0128051 A1
(43) Pub. Date: May 7, 2015

(54) USER-CONFIGURABLE DELIVERY OF INFORMATIONAL EVENTS

(71) Applicant: GOOGLE INC., Mountain View, CA (US)

(72) Inventors: Philip Noel George Strain, London (GB); William Kenneth Robin Montgomery, London (GB)

(73) Assignee: GOOGLE INC., Mountain View, CA (US)

(21) Appl. No.: 14/070,133

(22) Filed: Nov. 1, 2013

(51) Int. Cl. H04L 12/24

(52) U.S. Cl. CPC H04L 41/22
USPC 715/735

(57) ABSTRACT

A computer-implemented method for delivering informational events to a user of a computing device includes a processor and a memory. The method includes receiving, into the memory from the user of the computing device, content configuration information defining a first informational element. The method also includes receiving, into the memory from the user of the computing device, trigger event configuration information associated with a trigger event. The method further includes receiving, into the memory from the user of the computing device, target display interface configuration information defining a target display interface. The method also includes determining, by the processor, that the trigger event is satisfied based on the trigger event configuration information. The method further includes automatically retrieving the first informational element based on the content configuration information when the trigger event is satisfied. The method also includes transmitting the first informational element to the target display interface.

### BACKGROUND

This specification relates to delivering informational events to a user and, more particularly, to methods and systems for user-configurable delivery of informational events to one or more computing devices and other display interfaces accessible by the user, wherein informational events include presenting one or more elements of data to the user.

Internet users and other consumers of data may regularly visit the Internet or other data sources to consume information such as news events or articles, financial events such as current stock prices, or other data that evolves, changes, or occurs during the user's day or week. Each user may gravitate to certain sources based on the particular user's interests. For example, a user desiring financial market data because of an interest in an investment portfolio may access an Internet data source that provides regular updates to stock or bond prices. Some users may visit these data sources many times per day. The task of having to access these data websites periodically throughout the day can be time consuming, and can provide information to the user in an untimely manner

### BRIEF DESCRIPTION OF THE DISCLOSURE

In one aspect, a computer-implemented method for delivering informational events to a user of a computing device is provided. The computing device includes a processor and a memory. The method includes receiving, into the memory from the user of the computing device, content configuration information defining a first informational element. The method also includes receiving, into the memory from the user of the computing device, trigger event configuration information associated with a trigger event. The method further includes receiving, into the memory from the user of the computing device, target display interface configuration information defining a target display interface. The method also includes determining, by the processor, that the trigger event is satisfied based on the trigger event configuration information. The method further includes automatically retrieving the first informational element based on the content configuration information when the trigger event is satisfied. The method also includes transmitting the first informational element to the target display interface.

In another aspect, a computer system is provided. The computer system includes at least one processor and at least one memory. The memory includes computer-executable instructions that, when executed by said at least one processor, cause said at least one processor to receive content configuration information defining a first informational element. The computer-executable instructions also cause the at least one processor to receive trigger event configuration information associated with a trigger event. The computer-executable instructions further cause the at least one processor to receive target display interface configuration information defining a target display interface. The computer-executable instructions also cause the at least one processor to determine that the trigger event is satisfied based on the trigger event configuration information. The computer-executable instructions further cause the at least one processor to automatically retrieve the first informational element based on the content configuration information when the trigger event is satisfied. The computer-executable instructions also cause the at least one processor to transmit the first informational element to the target display interface.

In yet another aspect, computer-readable storage media having computer-executable instructions embodied thereon are provided. When executed by at least one processor, the computer-executable instructions cause the processor to receive content configuration information defining a first informational element. The computer-executable instructions also cause the processor to receive trigger event configuration information associated with a trigger event. The computer-executable instructions further cause the processor to receive target display interface configuration information defining a target display interface. The computer-executable instructions also cause the processor to determine that the trigger event is satisfied based on the trigger event configuration information. The computer-executable instructions further cause the processor to retrieve the first informational element based on the content configuration information when the trigger event is satisfied. The computer-executable instructions also cause the processor to transmit the first informational element to the target display interface.

### BRIEF DESCRIPTION OF THE DRAWINGS

FIGS. 1-5 show example embodiments of the methods and systems described herein.

FIG. 1 is a diagram depicting an example networked environment for configuring and delivering informational events by an informational event presentation system.

FIG. 2 is a block diagram of a computing device used for configuring and delivering informational events to users in the networked environment shown in FIG. 1.

FIG. 3 is a diagram of a user configuring an example informational event within the informational event presentation system shown in FIG. 1 using a computing device similar to the computing devices shown in FIGS. 1 and 2.

FIG. 4 is an example method for configuring the informational event presentation system shown in FIGS. 1 and 3 and delivering informational events to a user using the computing devices shown in FIGS. 1-3.

FIG. 5 is a diagram of components of an example informational event presentation system similar to the IEPS shown in FIGS. 1 and 3.

Like reference numbers and designations in the various drawings indicate like elements.

### DETAILED DESCRIPTION OF THE DISCLOSURE

Embodiments of the methods and systems described herein enable users to configure delivery of informational events of interest to their computing devices. More specifically, the methods and systems described herein facilitate configuration and delivery of “informational events” based on a plurality of parameters. An “informational event” is an event that presents one or more “informational elements” to the user through the user's computing device, where the informational element is the data being presented. In one example embodiment, a user configures an informational event based on at least three parameters: (1) the type of information that will be displayed (i.e., the “informational element”); (2) the conditions under which the event will happen (i.e., the “trigger event conditions”); and (3) where and how the information will be presented (i.e., the distribution mechanism or “display interface” used to present the event). As such, when all of the configured conditions are met (i.e., once the trigger event conditions are true), the informational element will be presented to the user on the configured display interface (i.e., one of the user's computing devices).

In some embodiments, the trigger event conditions are configurable based on a plurality of criteria such as, for example, a particular time schedule (e.g., “Mondays at 7 pm”), a current location of the user or the user's computing device (e.g., “at home” or “at work”), and when engaged in an activity (e.g., “running” or “on the bus”). Further, the display interface may be selected from a plurality of display interfaces associated with the user such as, for example, through a particular application on the user's smartphone, or through the user's social media application, through an interface with the user's specific computing device such as their tablet computer or their wearable computing device. As such, the user is able to configure what data they want to receive, precisely under what conditions they want to receive the data, and through what display mechanism they want to receive the data.

The methods and systems described herein may be implemented using computer programming or engineering techniques including computer software, firmware, hardware, or any combination or subset thereof, wherein the technical effects may be achieved by performing at least one of the following steps: (a) receiving, into the memory from the user of the computing device, content configuration information defining a first informational element; (b) receiving, into the memory from the user of the computing device, trigger event configuration information associated with a trigger event; (c) receiving, into the memory from the user of the computing device, target display interface configuration information defining a target display interface; (d) determining that the trigger event is satisfied based on the trigger event configuration information; (e) automatically retrieving the first informational element based on the content configuration information when the trigger event is satisfied; (f) transmitting the first informational element to the target display interface; (g) receiving trigger event configuration information including a trigger event including of one or more conditions, each of the one or more conditions defining a result that can be determined by the processor; (h) monitoring, by the processor, a status of the first set of one or more conditions; (i) receiving trigger event configuration information wherein the trigger event includes an activity event condition that is satisfied based on when the user is engaged in a first activity; (j) receiving content configuration information including a data source associated with the first informational element, and wherein retrieving the first informational element comprises retrieving the first informational element from the data source; (k) presenting to the user a graphical user interface on the computing device in which the user configures one or more of the content configuration information, the trigger event configuration information, and the target display interface configuration information; (1) presenting to the user, via the graphical user interface, a list including a plurality of target display interfaces; (m) receiving, from the user via the graphical user interface, a selection of a target display interface from the plurality of target display interfaces, the selected target display interface being included in the target display interface configuration information; and (n) defining the first informational element to include web analytics data.

The following detailed description illustrates embodiments of the disclosure by way of example and not by way of limitation. It is contemplated that the disclosure has general application to displaying informational events to users regardless of the type of computing device used for displaying the informational events.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

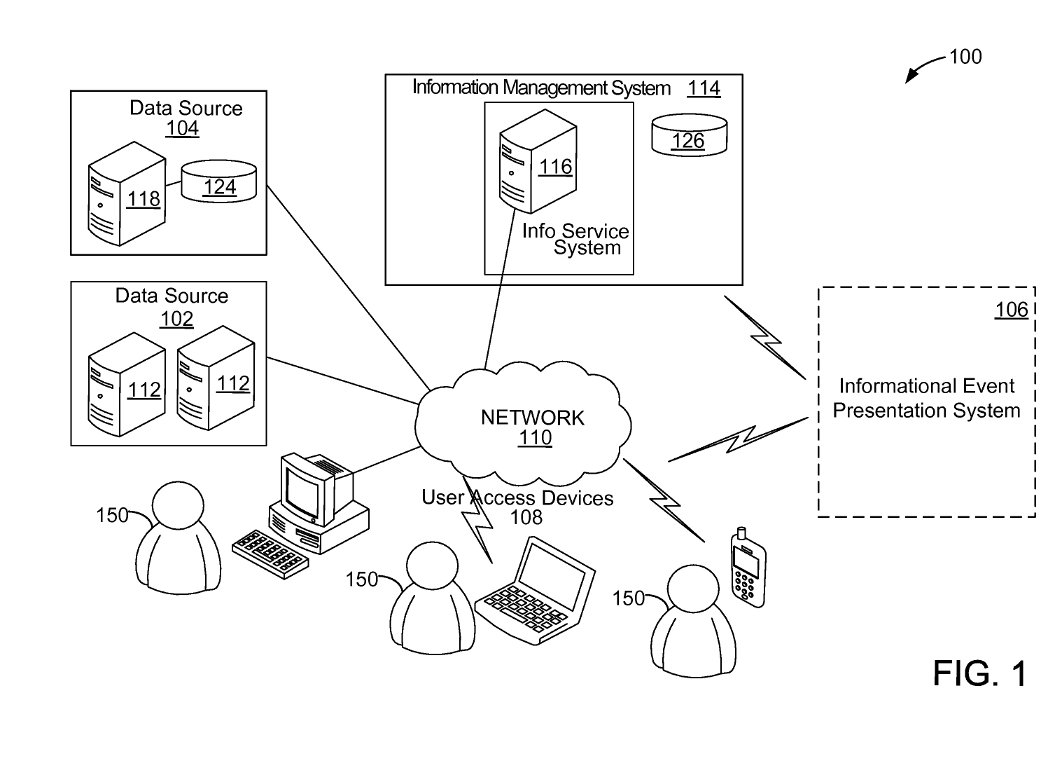

FIG. 1 is a diagram depicting an example networked environment 100 for configuring and delivering informational events by an informational event presentation system (IEPS) 106. Networked environment 100 includes consumers of information, such as users 150. In the example embodiment, users 150 consume information through the use of the IEPS 106 and computing devices such as user access devices 108. The IEPS 106 may be performed with one or more user access devices 108, or may also involve other computing components such as those shown in FIG. 1.

User access devices 108 may be, for example, desktop computing devices, tablet computing device, smartphones, and wearable computing devices. The user access devices 108 are communicatively coupled to a network 110, such as the Internet, and access information from data sources such as data source 102 and 104 and/or an information management system (IMS) 114 through the network 110. Data sources 102 and 104 are computing system that provides data on network 110 that may be consumed by users 150. In some embodiments, data source 102 provides web content on the Internet through web servers 112. In other embodiments, data source 104 provides data from a database server 118 and a database 124 using a communications gateway such as, for example, an application programming interface (API), calling a Uniform Resource Locator (URL), writing information to a database or datastore, a remote procedure call (RPC) across a network, or via a communications protocol such as Extensible Messaging and Presence Protocol (XMPP).

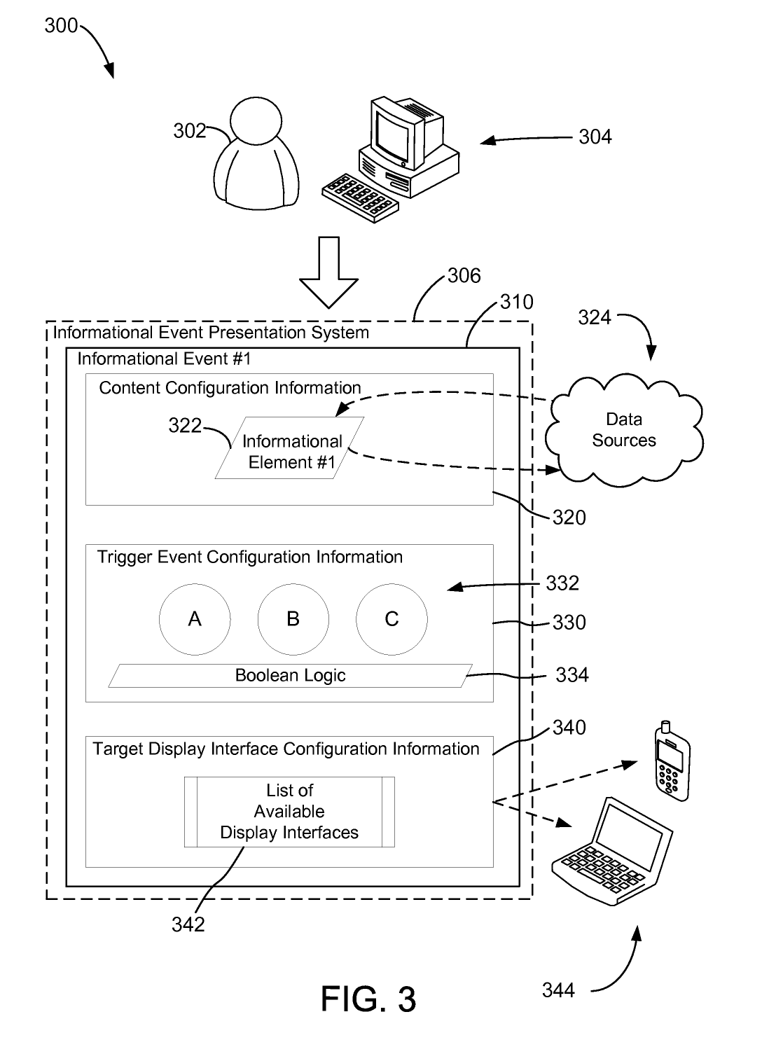

In the example embodiment, user access devices 108 may also interact with IMS 114, which includes an information service system 116 and a database 126. IMS 114 may include one or more data processing systems, such as servers or embedded systems, coupled to the network 110. It may also include one or more processes, such as server processes. IMS 114 is communicatively coupled to network 110 and may store information and/or perform management tasks associated with delivery of informational events to the users 150, as described in greater detail below with respect to FIG. 3.

IMS 114 may include or access one or more crawling, indexing, searching and/or retrieving modules (not shown in FIG. 1). These modules may collect data associated with informational elements that are presented to users 150 as a part of informational events. These modules may browse accessible resources (e.g., the World Wide Web, publisher content, data feeds, etc.) to identify, retrieve, index and store information. The modules may browse information and create copies of the browsed information for subsequent processing. The modules may also check links, validate code, harvest information, and/or perform other maintenance or other tasks. The modules may search information from various resources, such as the World Wide Web, publications, intranets, newsgroups, databases, and/or directories. The search modules may employ one or more known search, retrieval, or other processes to search and retrieve data. In some implementations, the modules may index crawled content and/or content received from data feeds to build one or more search indices. The search indices may be used to facilitate rapid retrieval of information relevant to a search query.

IMS 114 may include one or more interface or frontend modules for providing the various features to data sources 102 and 104, users 150, user access devices 108, and/or IEPS 106. For example, the IMS 114 may provide one or more APIs for allowing user access devices 108 and/or IEPS 106 to interact with IMS 114. In some examples, the front-end interfaces may be configured as web applications that provide users with network access to features available from IMS 114.

Further, each of the elements 102, 104, 106, 108, 110 and 114 in FIG. 1 may be implemented or associated with hardware components, software components, or firmware components or any combination of such components. The elements 102, 104, 106, 108, 110 and 114 can, for example, be implemented or associated with general purpose servers, software processes and engines, and/or various embedded systems. The elements 102, 104, 106, 108, 110 and 114 may serve, for example, as an information distribution network.

“Computing devices” such as, for example, user access devices 108 may include any devices capable of receiving information from the network 110. The user access devices 108 could include general computing components and/or embedded hardware or software systems optimized with specific components for performing specific tasks. Examples of user access devices include personal computers (e.g., desktop computers), mobile computing devices, cell phones, smart phones, head-mounted and other wearable computing devices, media players/recorders, music players, game consoles, media centers, media players, electronic tablets, personal digital assistants (PDAs), television systems, audio systems, radio systems, removable storage devices, navigation systems, set top boxes, other electronic devices and the like. The user access devices 108 can also include various other elements, such as processes running on various machines.

The network 110 may include any element or system that facilitates communication among and between various network nodes, such as elements 108, 112, 114 and 116. The network 110 may include one or more telecommunications networks, such as computer networks, telephone or other communications networks, the Internet, etc. The network 110 may include a shared, public, or private data network encompassing a wide area (e.g., WAN) or local area (e.g., LAN). In some implementations, the network 110 may facilitate data exchange by way of packet switching using the Internet Protocol (IP). The network 110 may facilitate wired and/or wireless connectivity and communication.

For purposes of explanation only, certain aspects of this disclosure are described with reference to the discrete elements illustrated in FIG. 1. The number, identity and arrangement of elements in the environment 100 are not limited to what is shown. For example, the environment 100 can include any number of geographically-dispersed data sources 102 and 104 and/or user access devices 108, which may be discrete, integrated modules or distributed systems. Similarly, the environment 100 is not limited to a single IEPS 106 and IMS 114 and may include any number of integrated or distributed IEPS and/or IMS systems or elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes running on separate machines or a single process running on a single machine.

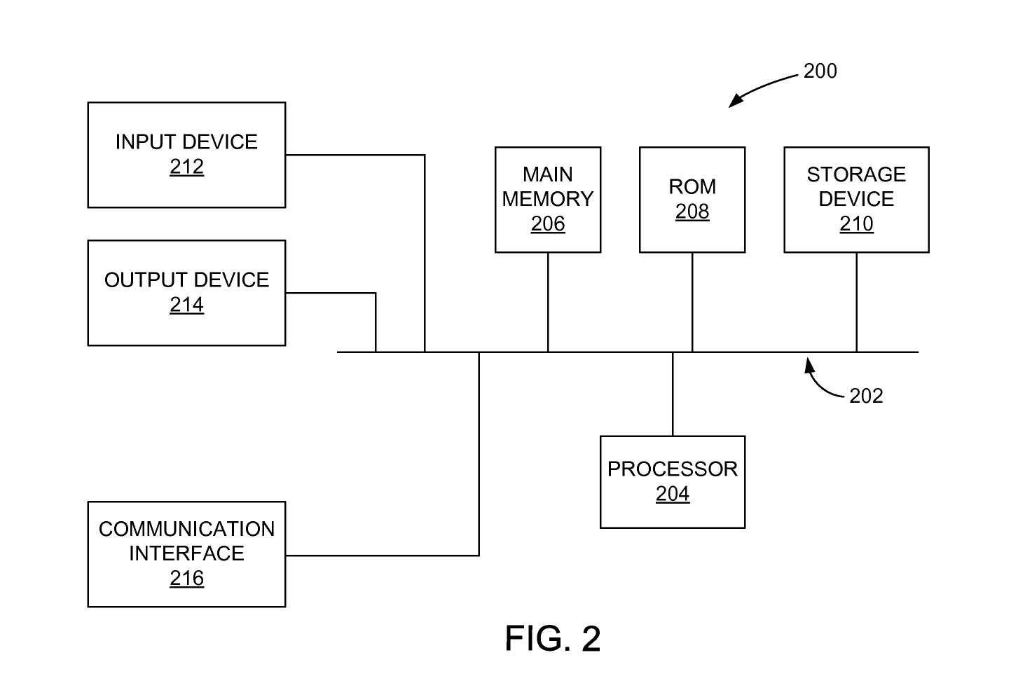

FIG. 2 is a block diagram of a computing device 200 used for configuring and delivering informational events to users in networked environment 100 (shown in FIG. 1). In some embodiments, computing device 200 may be one or more of the various computing devices in networking environment 100 (shown in FIG. 1) and/or IEPS 106. FIG. 2 shows an example of a generic computing device 200 intended to represent various forms of digital computers, such as laptops, desktops, workstations, personal digital assistants, servers, blade servers, mainframes, and other appropriate computers. Computing device 200 is also intended to represent various forms of mobile devices, such as personal digital assistants, cellular telephones, smart phones, tablet computers, wearable computing devices, and other similar computing devices. The components shown here, their connections and relationships, and their functions, are meant to be examples only, and are not meant to limit implementations of the subject matter described and/or claimed in this document.

In the example embodiment, computing device 200 could be user access device 108 or any of data processing devices 112, 114, or 116 (shown in FIG. 1). Computing device 200 may include a bus 202, a processor 204, a main memory 206, a read only memory (ROM) 208, a storage device 210, an input device 212, an output device 214, and a communication interface 216. Bus 202 may include a path that permits communication among the components of computing device 200.

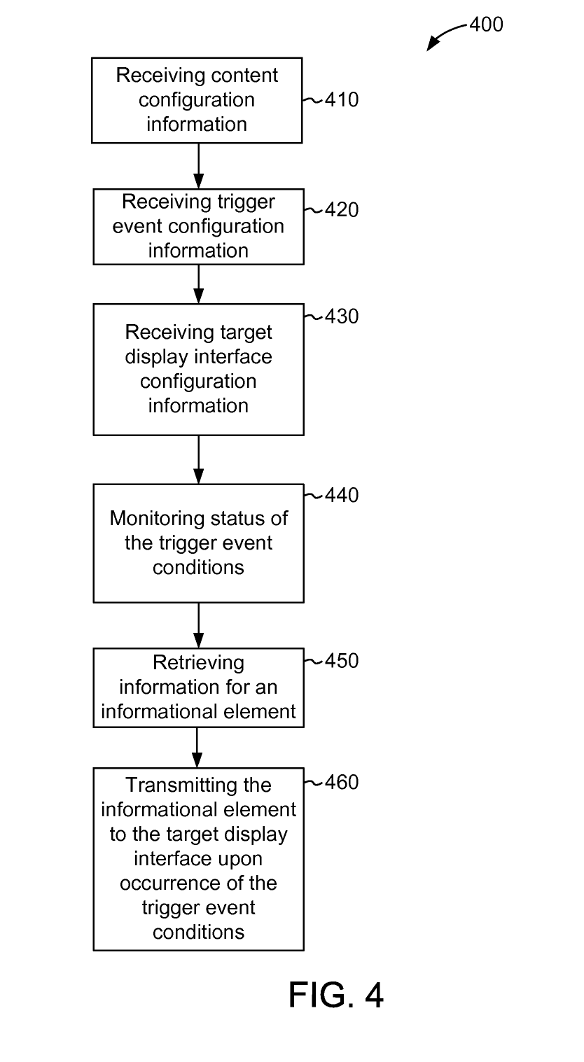

Processor 204 may include any type of conventional processor, microprocessor, or processing logic that interprets and executes instructions. Processor 204 can process instructions for execution within the computing device 200, including instructions stored in the memory 206 or on the storage device 210 to display graphical information for a GUI on an external input/output device, such as display 214 coupled to a high speed interface. In other implementations, multiple processors and/or multiple buses may be used, as appropriate, along with multiple memories and types of memory. Also, multiple computing devices 200 may be connected, with each device providing portions of the necessary operations (e.g., as a server bank, a group of blade servers, or a multi-processor system). In some embodiments, processor 204 is transformed into a special purpose microprocessor by executing computer-executable instructions or by otherwise being programmed. For example, processor 204 may be programmed with instructions such as illustrated in FIG. 4.

Main memory 206 may include a random access memory (RAM) or another type of dynamic storage device that stores information and instructions for execution by processor 204. ROM 208 may include a conventional ROM device or another type of static storage device that stores static information and instructions for use by processor 204. Main memory 206 stores information within the computing device 200. In one implementation, main memory 206 is a volatile memory unit or units. In another implementation, main memory 206 is a non-volatile memory unit or units. Main memory 206 may also be another form of computer-readable medium, such as a magnetic or optical disk.

Storage device 210 may include a magnetic, electronic, and/or optical recording medium and its corresponding drive. The storage device 210 is capable of providing mass storage for the computing device 200. In one implementation, the storage device 210 may be or contain a computer-readable medium, such as a floppy disk device, a hard disk device, an optical disk device, or a tape device, a flash memory or other similar solid state memory device, or an array of devices, including devices in a storage area network or cloud-based storage or other configurations. A computer program product can be tangibly embodied in an information carrier. The computer program product may also contain instructions that, when executed, perform one or more methods, such as those described above. The information carrier is a computer- or machine-readable medium, such as main memory 206, ROM 208, the storage device 210, or memory on processor 204.

The high speed controller manages bandwidth-intensive operations for the computing device 200, while the low speed controller manages lower bandwidth-intensive operations. Such allocation of functions is for purposes of example only. In one implementation, the high-speed controller is coupled to main memory 206, display 214 (e.g., through a graphics processor or accelerator), and to high-speed expansion ports, which may accept various expansion cards (not shown). In the implementation, low-speed controller is coupled to storage device 210 and low-speed expansion port. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

Input device 212 may include a conventional mechanism that permits computing device 200 to receive commands, instructions, or other inputs from a user 150, including visual, audio, touch, button presses, stylus taps, etc. Additionally, input device may receive location information. Accordingly, input device 212 may include, for example, a camera, a microphone, one or more buttons, a touch screen, and/or a GPS receiver. Output device 214 may include a conventional mechanism that outputs information to the user, including a display (including a touch screen) and/or a speaker. Communication interface 216 may include any transceiver-like mechanism that enables computing device 200 to communicate with other devices and/or systems. For example, communication interface 216 may include mechanisms for communicating with another device or system via a network, such as network 110 (shown in FIG. 1).

As described herein, computing device 200 facilitates the presentation of at least a configuration interface to a user for configuring and displaying informational events. Computing device 200 may perform these and other operations in response to processor 204 executing software instructions contained in a computer-readable medium, such as memory 206. A computer-readable medium may be defined as a physical or logical memory device and/or carrier wave. The software instructions may be read into memory 206 from another computer-readable medium, such as data storage device 210, or from another device via communication interface 216. The software instructions contained in memory 206 may cause processor 204 to perform processes described herein. Alternatively, hardwired circuitry may be used in place of or in combination with software instructions to implement processes consistent with the subject matter herein. Thus, implementations consistent with the principles of the subject matter disclosed herein are not limited to any specific combination of hardware circuitry and software.

The computing device 200 may be implemented in a number of different forms, as shown in the figure. For example, it may be implemented as a standard server, or multiple times in a group of such servers. It may also be implemented as part of a rack server system. In addition, it may be implemented in a personal computer such as a laptop computer. Each of such devices may contain one or more of computing device 200, and an entire system may be made up of multiple computing devices 200 communicating with each other.

The processor 204 can execute instructions within the computing device 200, including instructions stored in the main memory 206. The processor may be implemented as chips that include separate and multiple analog and digital processors. The processor may provide, for example, for coordination of the other components of the device 200, such as control of user interfaces, applications run by device 200, and wireless communication by device 200.

Computing device 200 includes a processor 204, main memory 206, ROM 208, an input device 212, an output device such as a display 214, a communication interface 216, among other components including, for example, a receiver and a transceiver. The device 200 may also be provided with a storage device 210, such as a micro-drive or other device, to provide additional storage. Each of the components are interconnected using various buses, and several of the components may be mounted on a common motherboard or in other manners as appropriate.

Computing device 200 may communicate wirelessly through communication interface 216, which may include digital signal processing circuitry where necessary. Communication interface 216 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver. In addition, short-range communication may occur, such as using a Bluetooth, WiFi, or other such transceiver (not shown). In addition, a GPS (Global Positioning system) receiver module may provide additional navigation- and location-related wireless data to device 200, which may be used as appropriate by applications running on device 200.

Computing device 200 may also communicate audibly using an audio codec, which may receive spoken information from a user and convert it to usable digital information. The audio codec may likewise generate audible sound for a user, such as through a speaker, e.g., in a handset of device. Such sound may include sound from voice telephone calls, may include recorded sound (e.g., voice messages, music files, etc.) and may also include sound generated by applications operating on computing device 200.

Computing device 200 may be implemented in a number of different forms. For example, it may be implemented as a cellular telephone, or as part of a smart phone, personal digital assistant, a computer tablet, or other similar mobile device.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system (e.g., computing device 200) that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In the example embodiment, computing device 200 is configured to store informational events that include informational elements from various other computing devices connected to computing device 200 through a communication network, and display those informational events on a display interface such as output device 214. Computing device 200 is further configured to manage and organize these events using at least one of memory 206, storage device 210, and ROM 208 using the techniques described herein.

FIG. 3 is a diagram of a user 302 configuring an example informational event 310 within an informational event presentation system (IEPS) 306 using a computing device 304 similar to the computing devices shown in FIGS. 1 and 2. In the example embodiment, the IEPS 306 is executed by a computing device such as, for example, computing device 304, IMS 114 (shown in FIG. 1), user access devices 108 (shown in FIG. 1), and/or computing device 200 (shown in FIG. 2). The user 302 configures the informational event 310 through interaction with IEPS 306. The informational event 310 is an event that presents one or more “informational elements” 322 to the user through one of the user's computing device, such as computing device 304 or user access devices 108. The computing device used to configure the informational element 310 may be the same computing device on which the informational element is presented, or a different computing device may be used for presentation of the informational event 310.

In the example embodiment, the informational event 310 includes three major configuration elements: content configuration information 320 (i.e., the type of information that will be displayed), trigger event configuration information 330 (i.e., the conditions under which the event will happen), and target display interface configuration information 340 (i.e., the distribution mechanism or the “where and how” the informational element 322 will be presented).

Content configuration information 320, in the example embodiment, includes at least one informational element 322 that describes the information to be displayed during the informational event 310. The informational element 322 may include reference to one or more external data sources 324 such as, for example, a publicly accessible web site from a web server such as web server 112 (shown in FIG. 1), or a database server 118 that provides access to data of interest through, for example, an API, or an information service system (IMS) server 116 (shown in FIG. 1) that provides customized informational elements for users 302 of the IMS 114 (shown in FIG. 1). Further, the informational element 322 and/or the content configuration information 320 may enable content “scraping” from the various external data sources 324. In other words, the content retrieved from data sources 324, when first retrieved by computing device 304, may initially contain a superset of data of which only a subset is desired to be viewed by the user (i.e., only a portion of the data may be “scraped” from the full content and presented as the informational element 322). In some embodiments, content configuration information 320 may include content from other devices belonging to the user, such as, for example, GPS location, images, or acceleration from a mobile computing device. Further, content configuration information 320 may include informational elements that may be computed, such as time and public holidays. In other embodiments, content configuration information 320 may include statistical data from, for example, web analytics tools, such as providing advertisement data.

In some embodiments, IEPS 306 performs data gathering functions of the informational element 322. In other embodiments, the server 116 of a client-server based system, such as shown in the environment 100 shown in FIG. 1, may perform the data gathering functions necessary for informational element 322. In still other embodiments, multiple informational elements 322 may be present within a single informational event 310 (i.e., when the informational event 310 occurs, the user 302 receives multiple elements of data, perhaps even from multiple sources).

Trigger event configuration information 330, in the example embodiment, includes one or more trigger event conditions 332. The trigger event conditions 332 generally describe the conditions that will cause the informational event 310 to occur (i.e., the conditions that will cause the informational element 322 to be displayed to the user 302). In the example embodiment, the user 302 selects one or more trigger event conditions 332 from a list of available types of conditions. The list of condition types may include, for example, a time of day, or one or more ranges of time, and referencing, for example, specific dates, or days of the week, or every day, or days of the month, such as “at 7:00 pm on Mondays” or “every day after 7:00 pm”.

In the example embodiment, the list of condition types also includes a travel mode of the user 302 and/or a mobile computing device associated with the user, such as through collection of geo-location data associated with the user and/or computing device, or through inference based on use of various computing devices. For example, geo-location data may be collected from a global positioning system (GPS) associated with a mobile computing device, and a travel mode condition may include conditional data such as “currently at work”, or “currently commuting”, or “currently walking/jogging”. The travel mode may include data based on estimated starting and/or ending locations, such as “currently commuting from work to home”, which may be inferred through historical data correlated with recent data from, for example, a GPS of the user's 302 mobile computing device. As used herein, the term “travel mode” may include not only information associated with users in transit, but may also refer to locational positions of users. For example, the user 302 may configure an informational event 310 to include a grocery store list of needed items when the user is in close proximity to the selected grocery store. As such, a present locational position from a mobile computing device's GPS system may be correlated with a GPS location of a grocery store, and thus the “travel mode” may alert “when near grocery store” (e.g., when within a pre-determined threshold distance from grocery store's GPS location).

The list of condition types, in the example embodiment, also includes an activity condition associated with the user 302 and/or one or more of the computing devices 304 and 344. An activity condition may be any condition that is sensible or otherwise determinable by the computing devices associated with the informational event 310. For example, the user 302 may wear or otherwise carry a mobile computing device that has access to vital statistics of the user 302, such as heart rate. As such, an activity condition may be based on the heart rate or other vital statistics of the user 302 (e.g., the activity of “exercising” may be configured to be true when heart rate is over a pre-determined threshold).

In some embodiments, conditions may also include external events and/or information-based events such as, for example, if a stock price of a stock in the user's investment portfolio moves by a pre-determined amount, or if the number of visitors to the user's website suddenly decreases. Some external events/information-based events of others may trigger events of the user. For example, if the user is socially connected to a friend, the user may configure and receive alerts when that friend arrives at a location or replies to an invitation. Additionally, the events may be configured to target a preferred display forum of the user. For example, if the user's stock changes more than a pre-determined amount, the user may want to receive notification through their wearable computing device, but if a friend replies to an invitation, the user may want to receive the notification via and email update.

In the example embodiment, trigger event conditions 332 are truth evaluated to determine whether and when IEPS 306 presents the informational event 310 to the user 302 (i.e., when informational event 310 “occurs”). For example, a time-based trigger event condition 332 of “at 7:00 pm on Mondays” is evaluated as “true” during one minute on each Monday of the week (i.e., between 7:00:00 pm and 7:00:59 pm on every Monday), and otherwise evaluates to “false”. A travel mode-based trigger event condition 332 such as, for example, “currently at work” or “currently walking”, is evaluated as “true” at the specific times when, for example, the user's mobile computing device is detected and evaluated as in that state.

In some embodiments, the trigger event conditions 332 may be subject to Boolean logic 334 in order to determine a single truth value for one or more trigger event conditions 332. For example, in some embodiments, the user 302 may configure a single trigger event condition 332 as negated by Boolean logic 334, such as “not” “currently at work” (i.e., the informational event would occur once the condition “currently at work” is not true, or in other words, is false). In some embodiments, multiple trigger events 332 may be combined together with Boolean logic 334. For example, the user 302 may wish to receive the informational element 322 during his evening commute from work to home, but the information may only be available after 7 pm. As such, the user 302 may configure two trigger events and combine them together, such as “after 7:00 pm” “and” “currently commuting”, where the “and” represents the Boolean logic 334 used to combine multiple truth values into a single truth value for the entire informational event. As such, trigger events 332 may be combined using Boolean logic 334 using logical operators commonly known in the art.

Target display interface configuration information 340, in the example embodiment, includes a list of available display interfaces 342 in which the informational event 310 may be presented to the user 302 (i.e., display mediums in which the informational element 322 may be presented). The list of display interfaces 342, in some embodiments, includes specific computing devices 304 and/or 344 associated with the user 302. For example, the user 302 may be associated with a desktop computer and/or several portable computing devices, such as a smartphone and a laptop, a tablet computing device, and/or a wearable computing device (e.g., computer glasses). In other embodiments, the list of display interfaces 342 includes display interfaces that are not device-specific (i.e., that are not necessarily associated with a specific computing device). For example, the list of display interfaces 342 may include display interfaces such as an email address (e.g., the user may receive an email as the “display” of informational element 322), a social media site (i.e., the user may receive the informational element 322 through their social media account), or a messaging service (i.e., the user may receive a text message through, for example, a cellphone). Alternatively, any such display interface that enables the systems and methods described herein may be used.

In some embodiments, a graphical user interface is presented to the user 302 on a computing device such as computing device 304. The user configures informational event 310 through use of the graphical user interface. In some embodiments, the user 302 is presented with a list including a plurality of target display interfaces, and the user 302 selects, by the user via the graphical user interface, a target display interface from the plurality of target display interfaces. The selected target display interface is thereby included in the target display interface configuration information.

During configuration, in some embodiments, the user 302 configures an informational event such as informational event 310. More specifically, the user 302 configures: (1) content configuration information 320 including at least one informational element 322; (2) trigger event configuration information 330 including one or more trigger events 332 and optionally Boolean logic 334; and (3) a selection of one or more display interfaces from the list of available display interfaces 342. In some embodiments, configuration information for informational event 310 may be stored on one or more personal computing devices of the user 302, such as computing device 304 and/or 344. In other embodiments, configuration information for informational event 310 may be centrally stored by a server system such as IMS 114 (shown in FIG. 1). Alternatively, any such architecture that enables the systems and methods described herein may be used.

During operation, the IEPS 306 monitors the truth value of the trigger event conditions 332 associated with the informational event 310. Upon occurrence of the informational event (i.e., when the trigger event configuration information is satisfied), the informational element 322 is displayed to one or more of the selected display interfaces 344. In some embodiments, at the time the trigger event configuration information is satisfied (i.e., at the time the informational event 310 occurs), the informational element 322 may be populated with outside data from data sources 324 prior to presentation to the user 302.

In some embodiments, one or more of the user's 302 computing devices 304 and/or 344 are programmed to manage informational event 310, and may also be configured as one of the target display interfaces of the list of available display interfaces 342. In other embodiments, such as in networked environment 100 (shown in FIG. 1), configuration information for informational events 310 may be stored and/or otherwise managed, in a client-server fashion, using a centralized server system such as IMS 114 (shown in FIG. 1). As such, trigger event configuration information may be monitored and/or evaluated, including the collection and analysis of data used by the trigger events 332, by either the user's computing devices 304 and/or 344 or IMS 114.

In some embodiments, the various functions of IEPS 306 may be performed by a single computing device, such as user access device 108 or computing device 304. In other embodiments, the various functions of IEPS 306 may be performed by multiple computing devices. For example, in one embodiment, the user 302 may have a desktop computing device such as computing device 304 from which they configure informational events 310. The informational events may be stored on and/or monitored by IMS 114, and the informational event may be displayed on a mobile computing device such as user access device 108.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

FIG. 4 is an example method 400 for configuring the IEPS 306 (shown in FIG. 3) and delivering informational events 310 (shown in FIG. 3) to a user using computing device 304 and/or 344 (shown in FIG. 3), computing device 200 (shown in FIG. 2), or the computing devices shown in networked environment 100 (shown in FIG. 1). In the example embodiment, method 400 includes receiving 410, into the memory from the user of the computing device, content configuration information defining a first informational element. In some embodiments, a data source is associated with the content configuration information. In other embodiments, data is retrieved 450 from the data source after the occurrence of a trigger event. Method 400 also includes receiving 420, into the memory from the user of the computing device, trigger event configuration information associated with a trigger event. In some embodiments, the trigger event configuration information includes a plurality of trigger events, one or more of which may be an activity event condition (i.e., indicating when the user is engaged in a first activity), a time-based condition, and a travel mode condition.

Method 400 further includes receiving 430, into the memory from the user of the computing device, target display interface configuration information defining a target display interface. In some embodiments, method 400 includes monitoring 440 status of the first set of one or more conditions (i.e., monitoring the truth value of the trigger conditions 332 shown in FIG. 3). Method 400 also includes displaying 460 the first informational element within the target display interface upon the occurrence of the trigger event. In some embodiments, the first informational element is only displayed when the trigger conditions are satisfied.

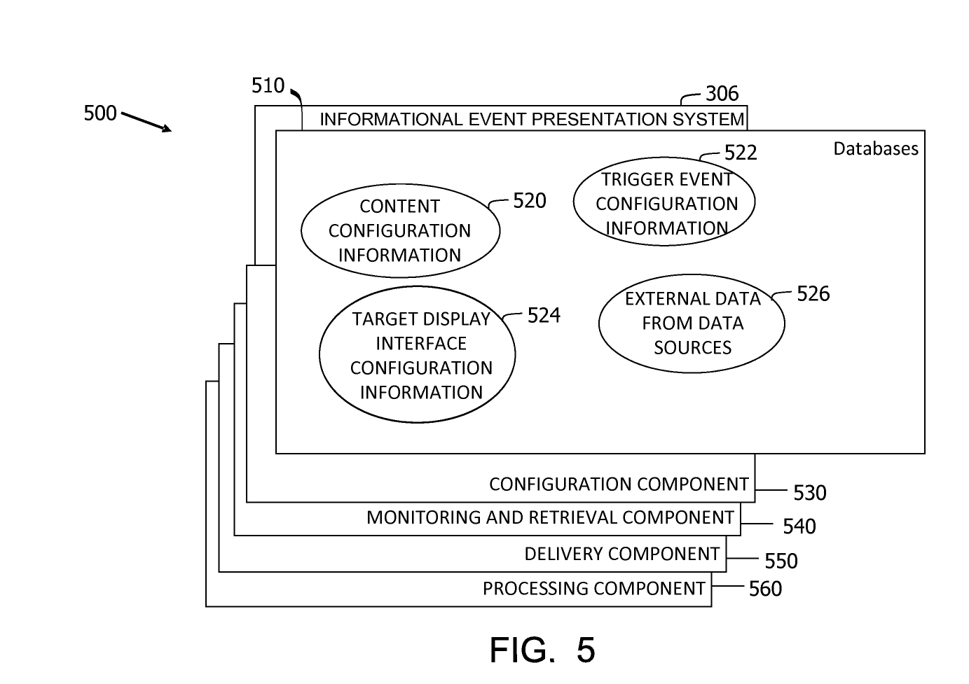

FIG. 5 is a diagram 500 of components of an informational event presentation system (IEPS) 306. In the example embodiment, IEPS 306 uses one or more computing devices, for example IMS 114 (shown in FIG. 1) and/or computing device 200 (shown in FIG. 2). FIG. 5 further shows a configuration of a database 510 which is coupled to several separate components within IEPS 306, which perform specific tasks.

In an example embodiment, database 510 is divided into a plurality of sections, including but not limited to, a content configuration information section 520, a trigger event configuration information section 522, a target display interface configuration information section 524, and an external data section 526. These sections within database 510 are interconnected to retrieve information pertaining to the operations and components described below. In some embodiments, database 510 is similar to database 126 (shown in FIG. 1).

IEPS 306 further includes a configuration component 530 for receiving configuration information associated with informational events 310 (shown in FIG. 3), including content configuration information 520, trigger event configuration information 522, and target display interface configuration information 524. IEPS 306 also includes a monitoring and retrieval component 540 for monitoring trigger events 332 and retrieving data from data sources 324 for informational elements 322 (shown in FIG. 3). IEPS 306 additionally includes a delivery component 550 for presenting informational events to users 302 through the target display interfaces 344. IEPS 306 additionally includes a processing component 660 for performing other operations associated with identifying relationships between content items.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the embodiments or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” “retrieving” “receiving” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

While the disclosure has been described in terms of various specific embodiments, it will be recognized that the disclosure can be practiced with modification within the spirit and scope of the claims.

What is claimed is:

1. A computer-implemented method for delivering informational events to a user of a computing device, the computing device including a processor and a memory, said method comprising:
receiving, into the memory from the user of the computing device, content configuration information defining a first informational element;
receiving, into the memory from the user of the computing device, trigger event configuration information associated with a trigger event;
receiving, into the memory from the user of the computing device, target display interface configuration information defining a target display interface;
determining, by the processor, that the trigger event is satisfied based on the trigger event configuration information;
automatically retrieving the first informational element based on the content configuration information when the trigger event is satisfied; and
transmitting the first informational element to the target display interface.

2. The method of claim 1, wherein receiving trigger event configuration information comprises a trigger event including of one or more conditions, each of the one or more conditions defining a result that can be determined by the processor.

3. The method of claim 2 further comprising monitoring, by the processor, a status of the first set of one or more conditions.

4. The method of claim 1, wherein receiving trigger event configuration information further comprises receiving trigger event configuration information wherein the trigger event includes an activity event condition that is satisfied based on when the user is engaged in a first activity.

5. The method of claim 1, wherein receiving content configuration information comprises receiving content configuration information including a data source associated with the first informational element, and wherein retrieving the first informational element comprises retrieving the first informational element from the data source.

6. The method of claim 1 further comprising presenting to the user a graphical user interface on the computing device in which the user configures one or more of the content configuration information, the trigger event configuration information, and the target display interface configuration information.

7. The method of claim 6 further comprising:
presenting to the user, via the graphical user interface, a list including a plurality of target display interfaces; and
receiving, from the user via the graphical user interface, a selection of a target display interface from the plurality of target display interfaces, the selected target display interface being included in the target display interface configuration information.

8. The method of claim 1, wherein receiving content configuration information further comprises defining the first informational element to include web analytics data.

9. A computer system comprising:
at least one processor; and
at least one memory comprising computer-executable instructions that, when executed by said at least one processor, cause said at least one processor to:
receive content configuration information defining a first informational element;
receive trigger event configuration information associated with a trigger event;
receive target display interface configuration information defining a target display interface;
determine that the trigger event is satisfied based on the trigger event configuration information;
automatically retrieve the first informational element based on the content configuration information when the trigger event is satisfied; and
transmit the first informational element to the target display interface.

10. The computer system of claim 9, wherein the trigger event includes a one or more conditions, each of the one or more conditions, wherein each of the one or more conditions defines a result that can be determined by the processor.

11. The computer system of claim 10, wherein, when executed by said at least one processor, the computer-executable instructions further cause said at least one processor to monitor a status of the first set of one or more conditions.

12. The computer system of claim 11, wherein the trigger event further includes an activity event condition that is satisfied based on when the user is engaged in a first activity.

13. The computer system of claim 9, wherein the content configuration information includes a data source associated with the first informational element, and wherein the computer-executable instructions further cause said at least one processor to retrieve the first informational element from the data source.

14. The computer system of claim 9, wherein, when executed by said at least one processor, the computer-executable instructions further cause said at least one processor to present to the user a graphical user interface on the computing device in which the user configures one or more of the content configuration information, the trigger event configuration information, and the target display interface configuration information.

15. The computer system of claim 14, wherein, when executed by said at least one processor, the computer-executable instructions further cause said at least one processor to:
present to the user, via the graphical user interface, a list including a plurality of target display interfaces; and
receive, from the user via the graphical user interface, a selection of a target display interface from the plurality of target display interfaces, the selected target display interface being included in the target display interface configuration information.

16. The computer system of claim 9, wherein the first informational element is defined to include web analytics data.

17. Computer-readable storage media having computer-executable instructions embodied thereon, wherein, when executed by at least one processor, the computer-executable instructions cause the processor to:
receive content configuration information defining a first informational element;
receive trigger event configuration information associated with a trigger event;
receive target display interface configuration information defining a target display interface;
determine that the trigger event is satisfied based on the trigger event configuration information;
retrieve the first informational element based on the content configuration information when the trigger event is satisfied; and
transmit the first informational element to the target display interface.

18. The computer program product of claim 17, wherein the trigger event configuration information comprises a trigger event including a first set of one or more conditions, each of the one or more conditions defining a result that can be determined by the processor.

19. The computer program product of claim 18, wherein the computer-executable instructions further cause the processor to monitor status of the first set of one or more conditions.

20. The computer program product of claim 19, wherein the trigger event further includes an activity event condition that is satisfied based on when a user is engaged in a first activity.

21. The computer program product of claim 17, wherein the content configuration information includes a data source associated with the first informational element, and wherein the computer-executable instructions further cause the at least one processor to retrieve the first informational element from the data source.

22. The computer program product of claim 17, wherein the computer-executable instructions further cause the processor to present to a user a graphical user interface on the computing device in which the user configures one or more of the content configuration information, the trigger event configuration information, and the target display interface configuration information.

23. The computer program product of claim 22, wherein the computer-executable instructions further cause the processor to:
present to the user, via the graphical user interface, a list including a plurality of target display interfaces; and
receive, from the user via the graphical user interface, a selection of a target display interface from the plurality of target display interfaces, the selected target display interface being included in the target display interface configuration information.

24. The computer program product of claim 17, wherein the first informational element is defined to include web analytics data.
